(19) United States
(12) Patent Application Publication
(10) Pub. No.: US 2016/0247219 A1
(43) Pub. Date: Aug. 25, 2016

(54) INTERACTIVE TRANSACTION SYSTEM FOR PHYSICAL MERCHANT STORES

(71) Applicant: Shopper Scientist LLC, Corbett, OR (US)

(72) Inventor: Herb Sorensen, Corbett, OR (US)

(21) Appl. No.: 14/627,981

(22) Filed: Feb. 20, 2015

(51) Int. Cl. G06Q 30/06; G06Q 30/02; G06F 17/30; G06Q 20/18

(52) U.S. Cl. CPC G06Q 30/0641; G06Q 20/18; G06Q 30/0277; G06Q 30/0639; G06Q 30/0629; G06F 17/3053; G06F 17/30867

(57) ABSTRACT

An interactive transaction system is provided. A terminal, located adjacent or in proximity to a merchandise display, comprises a touch screen device, associated with the product category, configured to present a subset of products within the product category, determining the subset of products within the product category according to an algorithm that may take into account a profile of a shopper interacting with the terminal, a location of the terminal inside the physical merchant store, and products that are located in proximity to the terminal. The terminal is further configured to receive a shopper selection associated with at least one of the products in the subset of products within the product category for fulfillment.

### BACKGROUND

The term long tail has gained popularity in the retailing world to describe the strategy of selling a large number of unique items with relatively small quantities sold of each. The related term big head is used to describe the strategy of selling a small number of unique items with relatively large quantities sold of each. Many stores in the world apply both strategies to attract shoppers and achieve sales. However, conventional stores that apply the long tail strategy often waste capital deploying floor space for inventory that accounts for only a small proportion of overall sales. In some extreme cases, 50% of unique items in a store may contribute only 5% of total store sales. On the other hand, conventional stores that apply the big head strategy, offering only a handful of selections in each product category, often lose customers who prefer to purchase products in the long tail, reducing potential sales.

In contrast, online stores, which do not need to deploy any retail floor space, have an advantage over conventional stores in applying the long tail strategy while saving capital. For example, a large proportion of the book sales of many online booksellers come from obscure books that are not available in conventional, brick-and-mortar stores. Recognizing these advantages that online retailers enjoy, many conventional retail stores have recently begun to apply some aspects of the online experience to the shopper's experience in brick-and-mortar stores. For instance, retailers from clothing boutiques to grocers have deployed touch screen devices in kiosks that shoppers can use to look up inventory and complete sales.

However, these technologies have yet to address the problem of capital that is wasted in deploying floor space for vast quantities of inventory that only contribute a small proportion of overall sales. Conventional retailers are reluctant to completely abandon retail floor space, since strategically designed floor spaces can help attract shoppers and generate foot traffic into the stores. However, existing technologies adopted by conventional retailers in brick-and-mortar stores have yet to achieve similar advantages that online retailers have in applying the long tail strategy to achieve a large proportion of overall sales selling a large number of unique items with relatively small quantities sold of each.

### SUMMARY

To address the above discussed issues, and provide physical merchant stores with similar advantages that online retailers enjoy in applying the long tail strategy, an interactive transaction system is provided. A terminal, located inside the physical merchant store adjacent or in proximity to a merchandise display, comprises a touch screen device, associated with the product category, configured to present a subset of products within the product category, the subset of products within the product category being determined according to an algorithm that may take into account a profile of a shopper interacting with the terminal, a location of the terminal inside the physical merchant store, and products that are located in proximity to the terminal.

The terminal is further configured to receive a shopper selection associated with at least one of the products in the subset of products within the product category for fulfillment.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The present disclosure is illustrated by way of example and not by way of limitation in the figures of the accompanying drawings, in which the like reference numerals indicate like elements and in which:

FIG. 1 shows a schematic depiction of an example interactive transaction system.

FIG. 2A shows a schematic depiction of an example merchandise display and terminal of the transaction system of FIG. 1, the terminal being situated adjacent to and within a store shelf, and communicating with the server of the transaction system of FIG. 1.

FIG. 2B shows a schematic depiction of another example merchandise display and terminal of the transaction system of FIG. 1, the terminal being situated adjacent to and laterally next to a store shelf, and positioned within an endcap display kiosk.

FIGS. 3A-C show schematic depictions of example terminals of FIGS. 2A-B, with differing displays of products.

FIG. 4 shows a schematic depiction of a computer network of the present invention.

FIG. 5 is a flowchart of a method according to one embodiment of the present invention.

FIG. 6 is a flowchart of a method according to another embodiment of the present invention.

FIG. 7 is a flowchart illustrating additional steps of the method of FIG. 6.

### DETAILED DESCRIPTION

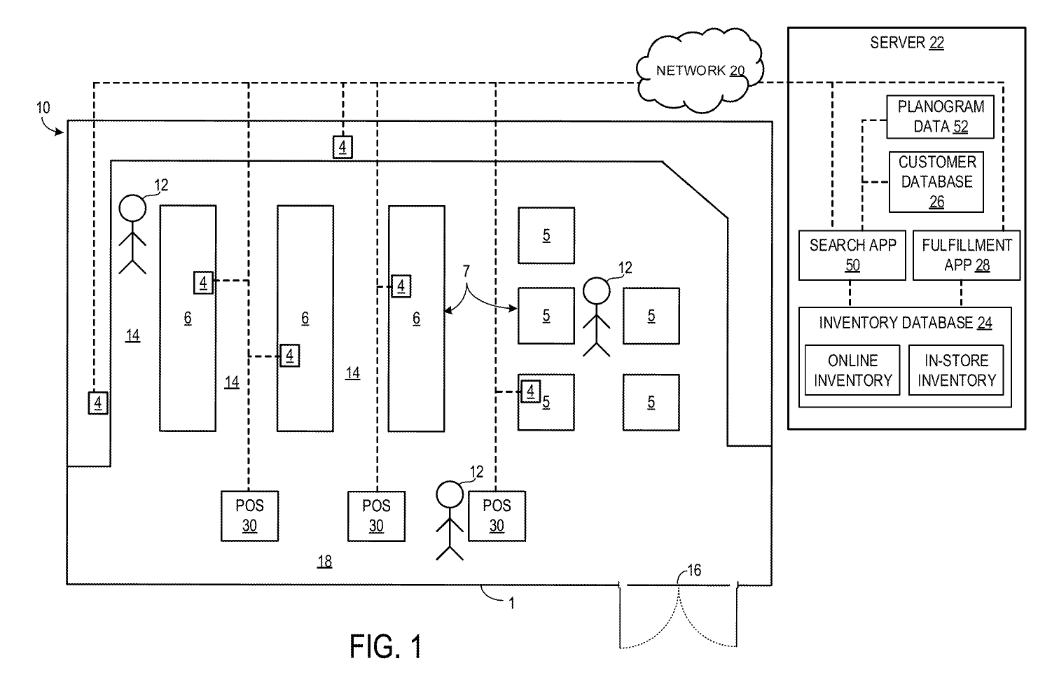

Accordingly, systems for applying the long tail strategy in a shopping environment in a physical merchant store are disclosed herein. FIG. 1 shows a schematic depiction of an example shopping environment 1 inside a physical merchant store, in which one or more shoppers 12 are shopping. It will be appreciated that the physical merchant store may be, for example, a physical building serving as a retail location in which various products are offered for sale. Example physical merchant stores include supermarkets, clothing retailers, department stores, hardware stores, restaurants, bazaars, malls, etc.

An interactive transaction system 10 for applying the long tail strategy in a shopping environment 1 is provided. The shopping environment 1 comprises a plurality of products arranged on shelves 6 and display counters 5, including a store shopping floor 18, a store entrance/exit 16, and shopping aisles 14 which are defined by the walls of the physical merchant store, aisle displays 5, and/or the shelves 6. Stores displays 5 and shelves 6 are not particularly limited, and may encompass windows, racks, revolving racks, tables, hangers, cases, freezers, cases, boxes, mannequins, and combinations thereof. In certain embodiments, the shopping environment may also include outdoor shopping space that surrounds the physical merchant store, or indoor mall shopping space that is adjacent to the physical merchant store. The system 10 comprises merchandise displays 7 that are located inside a shopping environment 1 in the physical merchant store, with terminals 4 that are located in the physical merchant store adjacent to or in proximity to each merchandise display 7. The merchandise displays 7 may be arranged in varied locations throughout the store 1. The merchandise displays 7 may include shelves 6 and bazaar displays 5, for example, or endcap displays, point of purchase displays, refrigerated shelving, service counters, etc. For example, the terminals 4 may be especially deployed in areas of the store that experience the most foot traffic by shoppers 12. The locations of the terminals 4 may also be determined by other factors, including the product category of the surrounding shelves 6, the placement of related products throughout the store, and analyses of the decision-making process employed by shoppers 12. For example, pasta sauce products may be placed in a merchandise display consisting of shelving within the pasta products aisle, or placed in proximity to shelving on which condiments are displayed if shopper tracking data indicates that shoppers generally prefer to pick up pasta sauces while picking up condiments, as one specific example.

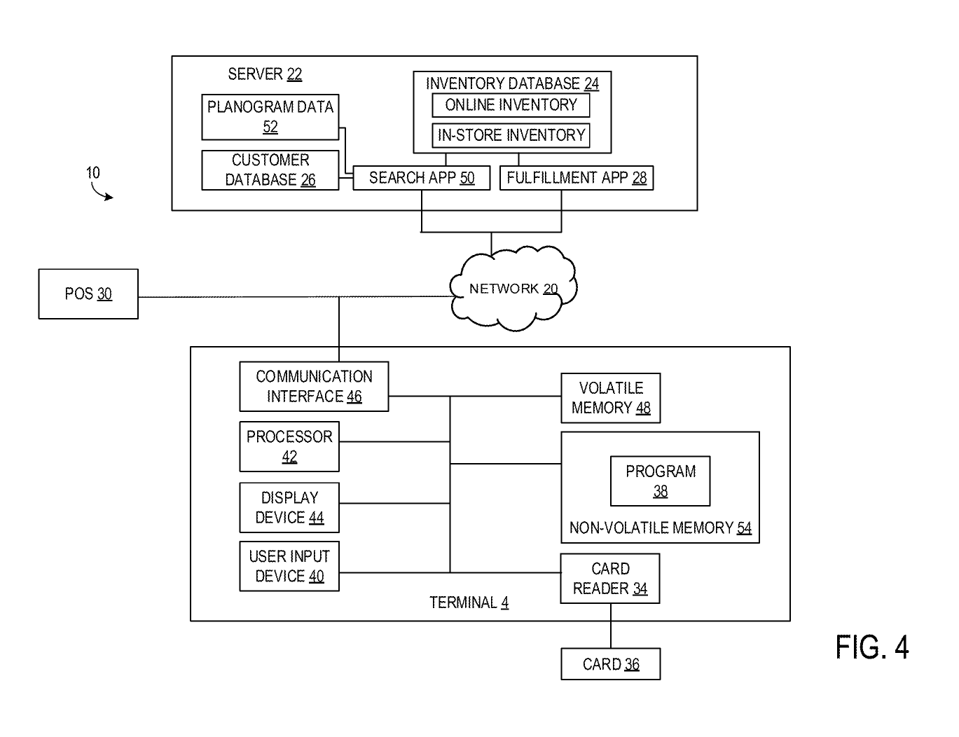

Terminals 4 inside the shopping environment 1 are connected within a computer network 20 that connects terminals 4 with one another and that links each terminal 4 to point of sale device 30, where shoppers 12 may check out items that were picked up in a shelf 6, display 5, or a merchandise display 7, or receive items that were ordered on a terminal 4. However, in other embodiments, the terminal 4 itself may also function as the point of sale device, so that the shopper may not be required to walk to a point of sale 30 to carry out a purchase. In the preferred embodiment, the computer network 20 is a secure wireless network including wireless access points to which terminals 4 connect within the physical merchant store, but the network may also be a wired network. The computer network 20 is connected to a server 22 that provides an inventory database 24 comprising an in-store inventory and online inventory, customer database 26, planogram data 52, a search application 50, and a fulfillment application 28. The computer network 20 may comprise a wired and/or wireless communication network. Additional technical details of the hardware architecture of the interactive transaction system 10 are discussed below in relation to FIG. 4.

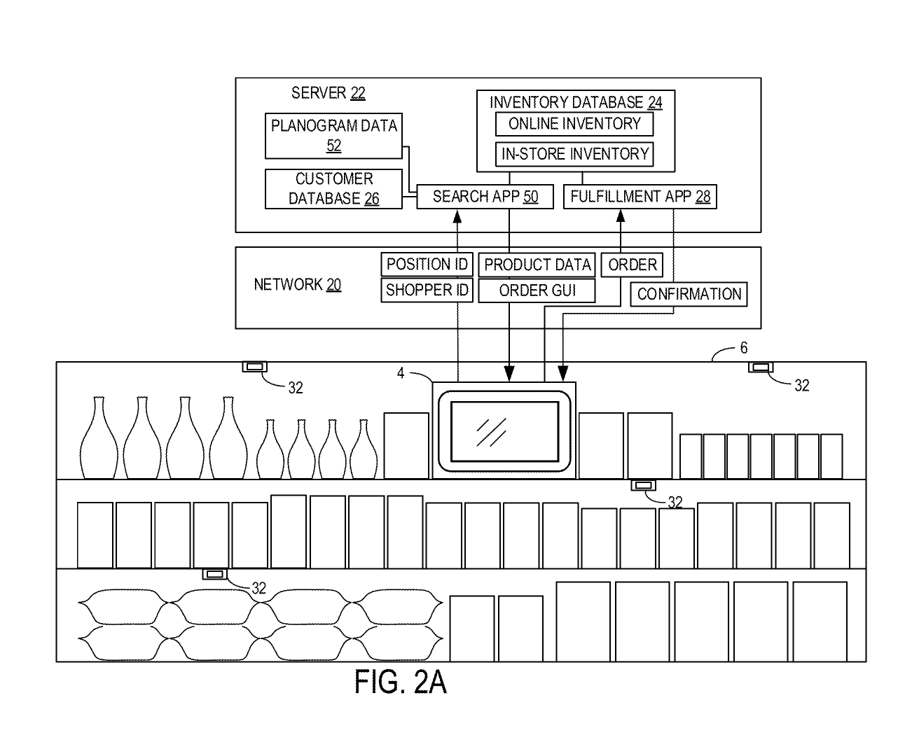

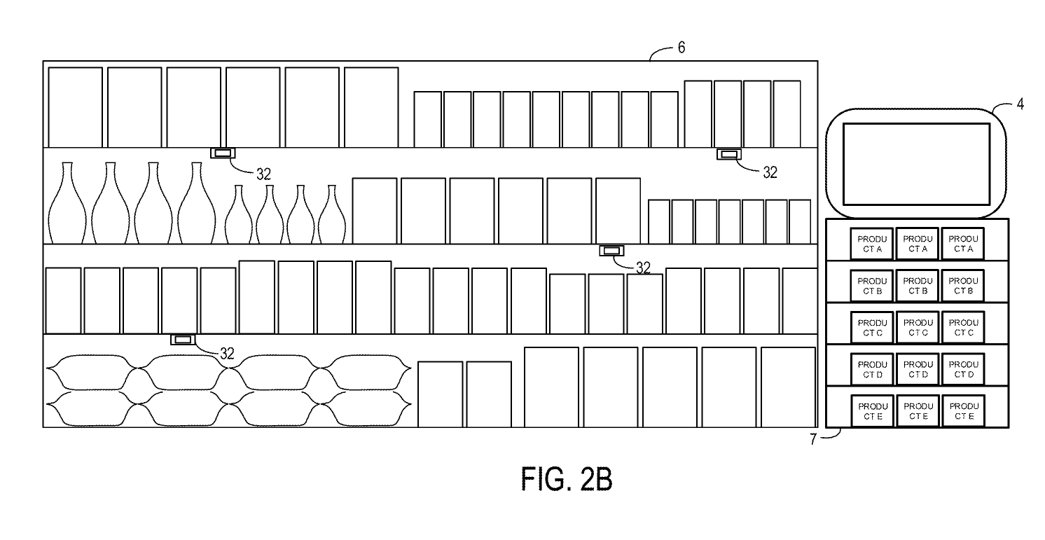

In each of the embodiments illustrated in FIGS. 2A and 2B, a terminal 4 is located adjacent to or in proximity to a merchandise display 7. Each merchandise display 7 contains a subset of products within a product category. Typically, surrounding shelf space is occupied by better selling products within a product category, i.e., so-called big head inventory, enabling a shopper 12 to casually grab such a top selling product and go. On the other hand, the terminal 4 facilitates purchases in the long tail inventory, i.e., the inventory within the product category which is not within a top selling selection of products that are displayed in the merchandise display 7, so that the store owner may devote less shelf space to those long tail items, more of which may be stored in a stock portion of the physical merchant store or a warehouse. The terminal may also provide a wireless transmitter to indicate the location or position of shoppers at terminals inside the store. The terminal 4 may generate a position identifier by self-sensing its location within the shopping environment by referring to planogram data that is stored on a server 22, or by receiving input from an administrator who inputs its location manually, for example. When the planogram data also indicates the location of each product within the physical merchant store, the terminal 4 may generate a position identifier that identifies a location within the planogram, and thus indicates a position of the terminal relative to each product in the planogram. Terminals may be connected to a source of AC or DC power inside the store. Alternatively, the terminals may include an internal power source such as a battery.

FIG. 2A illustrates an embodiment in which the terminal 4 is mounted on a shelf 6, oriented toward the shopper. FIG. 2B illustrates an embodiment in which the terminal 4 and merchandise display 7 may be integrated into a kiosk, which includes shelves and products placed on the shelves in the merchandise display 7, and an integrated housing for terminal 4 in one assembly.

Typically, the terminal 4 sends a position identifier and a shopper identifier to a search application 50 on the server device 22. The shopper identifier may be inputted by the shopper by touch input, via a card reader, scanning a QR code by a camera on the terminal 4, via wireless detection of an RFID card of the shopper containing the code, via Bluetooth or other wireless communication with a smartphone or other device storing the shopper identifier, etc. The position identifier may be generated by terminal 4 by self-sensing its location within the shopping environment, or by an administrator inputting its location manually. The position identifier may be a location within a planogram of the store, for example. The search application 50 identifies the location within planogram data 52 for the physical merchant store, stored at the server device 22, and identifies a shopper profile associated with the received shopper identifier within a customer database 26. The search application 50 may identify various shopper profile characteristics, and may identify a product category from the planogram data 52 for products that are adjacent to the position of the terminal 4, and may send a search query to the inventory database 24 to find matching online and/or in-store inventory that match the shopper profile characteristics and the product categories of the adjacent products, as determined from the planogram data 52. Such product data is typically ranked according to various ranking criteria, as discussed in detail below, and sent to the terminal 4 along with data for displaying an order GUI on the terminal 4. The terminal 4 may, in turn, receive an order from a user of the terminal 4 for a product depicted on the terminal 4, which order may be sent to a fulfillment application 28 that is associated with a payment regimen, such as Apple Pay, PayPal, or other payment services. Once the order is verified at the fulfillment application 28, a confirmation of order receipt may be displayed on the terminal 4. The ordering process is also described in detail below.

In certain embodiments, shopping aids 32, or audio aids and/or visual aids in the shopping environment, may guide shoppers to products, especially those in the big head inventory and those in a limited selection of the long tail inventory that is provided throughout the shopping environment. For example, in certain embodiments, a shopper may browse for a product in a terminal 4, select it, and a shopping aid 32 may direct the shopper to the selected product that is located in relatively close proximity to the terminal 4 by activating the audio and/or visual aids. In other embodiments, the kiosks may be easily moveable by store personnel on the shopping floor 18, having wheels and the like, that allow store personnel to adjust the placement of each kiosk in the shopping environment 1 to adapt to changes in shopping behavior. For example, before Christmas, a merchandise display with fruitcakes may be strategically moved to a store aisle featuring Christmas ornaments, or conversely, a merchandise display with Christmas ornaments may be strategically moved to a store aisle featuring fruitcakes.

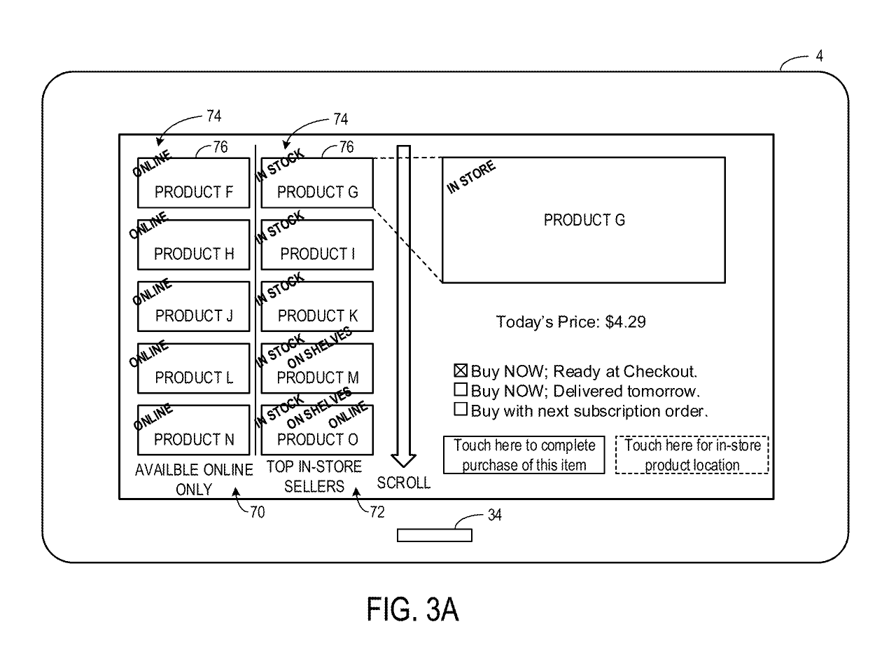

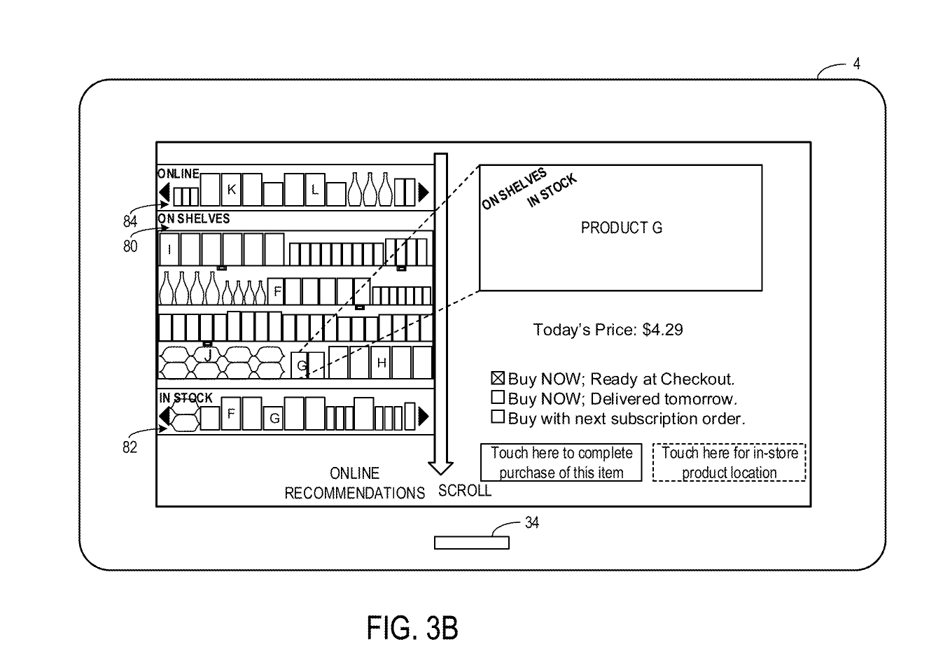

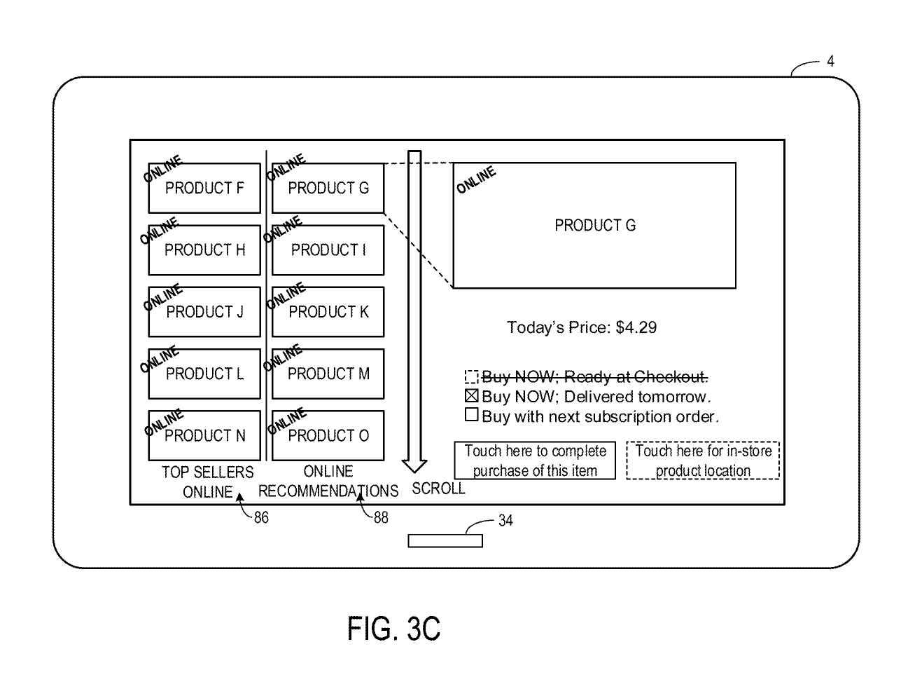

FIGS. 3A-C illustrate three embodiments of terminal 4. In each of the embodiments, terminal 4 comprises a touch screen device, associated with a product category, configured to: present a subset of products within the product category, the subset of products within the product category being determined according to an algorithm that may take into account a profile of a shopper interacting with the terminal, a location of the terminal inside the physical merchant store, and products that are located in proximity to the terminal, and receive a shopper selection associated with at least one of the products in the subset of products within the product category for fulfillment. The algorithm may also be based on a sales history associated with the profile of the shopper, and other factors discussed herein. In some embodiments, the algorithm may be based on an overall sales history associated with profiles of multiple shoppers, preferences of the shopper, the current position of the shopper relative to the terminal and products within the physical merchant store, inventory data, sales volume, the demographic profile of the shoppers who typically frequent the physical merchant store, random selection, payments made by advertisers, and other factors. In other embodiments, the algorithm may preferentially choose sponsored or promoted products within the product category to present to the shopper. The algorithm may be based on a saleable inventory in a stock portion of the physical merchant store or a warehouse. With the terminal 4, a shopper can select from a selection of products that were not included in the merchandise display, allowing the shopper to scroll through them to view a broadening selection of products, until the shopper makes a selection and indicates the desired purchase mode. In the preferred embodiment, the touch screen device is provided by the retailer, but in other embodiments, the shopper may provide the touch screen device with an application that is provided by the retailer. Terminals are configured to display detailed information, including in-store product location information, and purchase prices of the products for sale within a product category that is assigned to the terminal. The purchase price that is displayed on the terminal may be determined at least in part by the identity of the shopper interacting with the terminal. The terminal interface may also have other features to facilitate sharing of browsed products by the shopper.

The presentation of the subset of products within the product category may take various forms. For example, as illustrated in FIG. 3A, the products may be represented by icons that a user may scroll through in an intuitive, user-friendly GUI to easily identify the products that are in an in-store inventory and those that are available online. Users may even be able to identify products within the in-store inventory that are currently located on the shelves and merchandise displays of the physical merchant store, located within a stock portion of the physical merchant store, located within a local warehouse situated in proximity to the physical merchant store, or alternatively located within a remote warehouse. The GUI of FIG. 3A is configured to display in a first region 70 including a ranked list of products is generated based related to the position of the terminal relative to other product categories within the store, and to display in a second region 72 a ranked list of products that is generated without regard to the location of the terminal relative to other product categories in the store. In the first region 70 of FIG. 3A, the GUI displays products that are available only online, and provides a graphical indication 74 of the online availability in the form of a label ONLINE on each product icon 76. The second region 72 displays products that are top sellers in the store, and also provides an indication 74 in the form of a label ONLINE, IN STOCK, or ON SHELVES, to indicate to the user the manner in which the product is available for purchase. Selection of a particular product icon such as Product G, causes the icon to be displayed in a large format, and enables the user to select a purchasing option, as discussed below.

Alternatively, as illustrated in FIG. 3B, in the intuitive, user-friendly GUI, the products may be digitally represented as a 2 or three dimensional virtual reality rendering corresponding to the product layout of a physical merchant store. The product layout may be a representation of a merchandise display, which a user may interact with to easily identify the products that are in an in-store inventory and those that are available online. In the depicted embodiment, the ON SHELF inventory is represented in region 80, whereas the IN STOCK inventory (i.e., inventory that is in-stock but not on shelves) is represented in region 82 and the ONLINE inventory is represented in region 84.

In contrast to the embodiments illustrated in FIGS. 3A and 3B, which display products available on shelf, in store, and online, FIG. 3C illustrates an embodiment of the GUI of terminal 4 configured to display only products that are available online, and not to display products that are available in store. In this embodiment, top online sellers are displayed in a first region 86 and recommended products, which are generated based on the position of the terminal relative to adjacent products and/or product categories in the store, and optionally the shopper profile, are displayed in online recommendations region 88. In this embodiment, the BUY NOW option is crossed out and not selectable.

In one specific use case scenario, a terminal and merchandise display may be provided adjacent to pasta products in a shopping environment in a grocery store. The terminal may be associated with the pasta product category, configured to choose and present a subset of products within the pasta product category, and receive a shopper selection associated with at least one of the products in the subset of products for fulfillment. The merchandise display may include the top selling brands of spaghetti, while the terminal allows shoppers to browse and purchase less popular brands of spaghetti. If the shopper profile indicates that shopper has a sales history of purchasing only generic brands of pasta sauce, then the subset of products may include generic pasta sauce. If the terminal is located in proximity to cheese products, then the subset of products may include cheese products. If the terminal is located in the organic foods department, then the subset of products may include only organic pasta sauce and cheese products. Alternatively, if the overall shopper demographic in the store overwhelmingly prefers pasta product A, then pasta product A may be preferentially included in the subset of products. A shopper selecting pasta product A on the terminal display may see detailed information about pasta product A, including nutritional facts, ingredients, sample recipes, coupons and deals, and pricing information. Profiles of multiple products may be displayed side-by-side on the display to allow for convenient comparison shopping on the terminal 4.

The terminal 4 may be further configured to handle purchases in three modes, but only after the request to purchase and receive purchased products during the current visit is accepted when the one or more products selected by the shopper is confirmed to be in a saleable inventory in a stock portion of the physical merchant store. In the first mode, the terminal receives a shopper request to purchase and receive during current visit at least one of the products selected by the shopper. Once the purchase order is transmitted through the computer network of the physical merchant store, the at least one of the products selected by the shopper are retrieved from stock by robotic machine or by store personnel in the stock portion of a physical merchant store, a local warehouse that is located in proximity to the physical merchant store, or a remote warehouse. As illustrated in FIG. 3C, if the selected item is not available for purchase during the current visit, the first mode is not be available to the shopper for selection.

In reference to FIG. 3C, if the request to purchase and receive purchased products during current visit is rejected when the at least one of the products selected by the shopper is not in a saleable inventory stored in a stock portion of the physical merchant store, or if the system is configured to only display products that are available online, then the shopper may choose the second or third modes, by selecting the appropriate selector (e.g., checkbox). In this manner the terminal receives the shopper request to purchase for later delivery (second mode) or to purchase with the predetermined subscription order (third mode) the at least one of the products selected by the shopper. In the second mode, the terminal receives a shopper request to purchase for later delivery at least one of the products selected by the shopper. This mode is intended to be one of two modes that the shopper might select if a selected product is not available for purchase during the current visit. The shopper would be able to designate a destination for delivery, choosing to pick up the product at a home or business address, in the current physical merchant store, or another physical merchant store. The shopper would also be able to choose a mode of delivery, choosing various shipping speeds and services.

In the third mode, the terminal receives a shopper request to purchase with a predetermined subscription order at least one of the products selected by the shopper. This mode is intended to be one of two modes that the shopper might select if a selected product is not available for purchase during the current visit. If a shopper already has a subscription order in place, in which selected products are automatically purchased and delivered at a regular schedule, a shopper may choose to bundle the delivery of the at least one or more products in the current purchase into the next delivery of the existing subscription order.

Shoppers may identify themselves through a card reader that is provided on the terminal 4, including a means for reading shopper identifier information from a magnetic strip or a microchip that may be located on the shopper's card. If the shopper has a card that is associated with a shopper profile, the user may swipe the card through the card reader 34 or scan a microchip, thereby providing a shopper identifier to the terminal. Thus, a profile of the shopper can be authenticated using a card with a magnetic stripe or a microchip. Other embodiments of the terminal may omit the card reader 34. For example, in other embodiments, the shoppers might be authenticated by entering a unique alphanumeric sequence, such as a user ID and password, or use other identification devices such as QR code reader, fingerprint reader, iris reader, wireless detection of an RFID card of the shopper containing a code, Bluetooth or other wireless communication with a smartphone or other device storing the shopper identifier, etc. Authentication systems may also accommodate secure mobile payment services, such as APPLE® PAY, that let mobile devices wirelessly communicate with point of sale systems to authenticate the shopper.

A shopper may also be presented on the terminal 4 with advertisements that include suggestions for products that the shopper may be interested in, coupons for products, and special offers. The presented advertisements may be based on a sales history associated with the profile of the shopper, sales history associated with profiles of multiple shoppers, the demographic profile of the shoppers who typically frequent the physical merchant store, preferences of the shopper, other information related to the shopper, random selection, payments made by advertisers, and other factors. In other embodiments, the advertisements may preferentially present saleable inventory in a stock portion of the physical merchant store or a warehouse.

Referring to FIG. 4, an interactive transaction system 10 is depicted. The terminal 4 may be a touch screen computing device typically including a processor 42 linked by a communications bus to a user input device 40 (e.g. touch screen, keyboard, or mouse), display device 44 (e.g. touch screen or monitor), communication interface 46 (e.g. network card), volatile memory 48 (e.g. RAM), non-volatile memory 54 (e.g. flash memory, hard drive, ROM, etc.) storing a program 38, and a card reader 34 configured to read corresponding cards 36, such as cards with magnetic stripes or microchips. Processor 42 is configured to execute a program 38, stored in the volatile memory 48, using portions of volatile memory 48 and non-volatile memory 54. Communication interface 46 is typically configured to connect to computer network 20 to establish respective communications links with the interactive transaction system 10 and the server 22. It will be appreciated that there may be a variety of intermediary devices that may facilitate the connection between the terminal and the server and the point of sale. For example, a routing device (not shown) positioned within or adjacent to the shopping environment may be configured to receive signals (e.g. wired/wireless) from the server 22. The routing device may be further be configured to relay the signals over a network (e.g., VPN) to the terminal 4. In less preferable embodiments, the functionality of the terminal 4 may also be distributed among multiple computing devices. For example, a shopper's personal tablet computing device may also function as a terminal 4.

The server 22 may provide an inventory database 24 comprising an online inventory and an in-store inventory, customer database 26, planogram data 52, a search application 50, and a fulfillment application 28. The inventory database 24, closely integrated with the search application 50 and the fulfillment application 28, is ideally comprehensive, covering all products that are in a saleable inventory in a stock portion of the physical merchant store, a local warehouse in proximity to the physical merchant store, or a remote warehouse. In certain embodiments, saleable inventory that requires a longer delivery time to reach the shopper may also be included, such as an online inventory. The inventory database 24 may have precise, real time information about each product in the saleable inventory, including quantities in stock, physical location of each item, detailed product information, purchase histories, shipping histories, and other pertinent information. Automated systems, such as RFID tags, may be employed to facilitate the integration of each item into the inventory system for better management. To record the physical location of each item, products may be presented within a virtual store space according to planogram data 52, or a digital layout of the physical merchant store, storing information about the location of each product in the physical merchant store relative to each terminal 4. The planogram data 52, closely integrated with the search application 50, may also be used to store other information in relation to the virtual store space, recording information about shopper foot traffic and shopper interest in each product as monitored by a shopper tracking system.

The customer database 26, closely integrated with the search application 50, may store shopper profiles associated with shopper identifiers, including sales histories, virtual shopping carts, purchase orders, bookmarks, wish lists, and browsing histories. The virtual shopping cart for each shopper is maintained within a customer database 26 that is accessed when the shopper sends a request to purchase and receive at least one of the products selected by the shopper. However, in other embodiments, the virtual shopping cart may be maintained in a customer database 26, or a database that integrates both inventory and customer information.

A fulfillment application 28 calculates a bill for the shopping cart items, or at least one of the products selected by the shopper, and initiates a fulfillment process. At the terminal 4, the fulfillment application 28 accepts a shopper selection of a mode of purchase and finalizes a purchase. If a shopper picked up at least one item in a merchandise display for purchase, the shopper checks out the item at the point of sale 30, which is connected to and communicates with each terminal 4 and the network 20 and has full access to the customer database 26 and inventory database 24 through the network 20. If a shopper has purchased at least one item through the terminal 4 to purchase and receive during the current visit, the shopper receives the item at the point of sale 30 from a robotic machine or store personnel that has retrieved the ordered and purchased item from a stock portion of the physical merchant store, a local warehouse in proximity to the physical merchant store, or a remote warehouse. If the shopper has chosen to purchase for later delivery at the point of sale 30 at least one item, then the shopper also receives the item at the point of sale 30. In other embodiments, the point of sale 30 may be conceived as store personnel with mobile computing devices that function as points of sale.

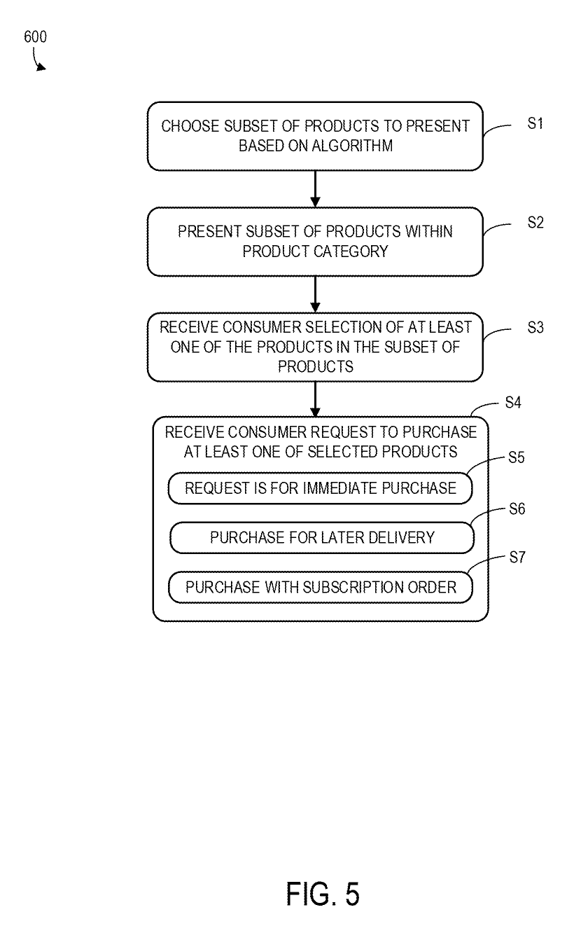

With reference to FIG. 5, at step S1, the method 600 may include choosing a subset of products to present based on an algorithm. At step S2, the device presents a subset of products within the product category. At step S3, the consumer selects at least one of the products in the subset of products. Following step S3, consumer reaches a decision-making point at step S4, where the consumer must make a decision on purchasing the selected at least one of the products. Consumer may choose to purchase and receive at least one of selected products during current visit (step S5), purchase for later delivery at least one of the selected products (step S6), or purchase with a subscription order at least one of the selected products (step S7). These options are not intended to be limiting embodiments—other modes of purchase may be provided for the consumer at decision-making point step S4.

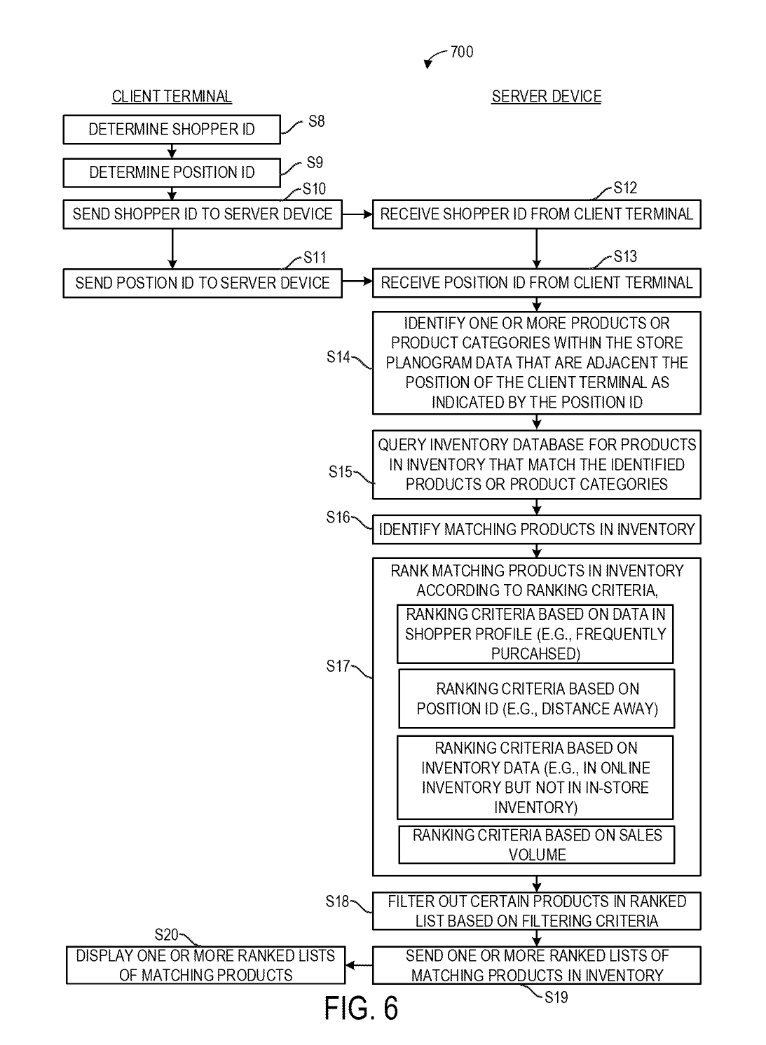

With reference to FIG. 6, a method 700 according to another embodiment is depicted. The method 700 may include determining a shopper identifier (step S8), determining a position identifier (step S9), and sending the shopper identifier (step S10) and position identifier to a server device (step S11). The server device receives the shopper identifier (step S12) and position identifier from the client terminal (step S13). The search application within the server device identifies one or more products or product categories within the store planogram data that are adjacent to the position of the client terminal as indicated by the position identifier (step S14). The search application sends a search query to the inventory database to find matching online and/or in-store inventory that matches the identified products or product categories (step S15). Once the matching products in the inventory are identified (step S16), products in the inventory are rank matched according to ranking criteria (step S17). For example, the ranking criteria may be based on data in the shopper profile (e.g., frequently purchased products), position ID (e.g., distance from in-store products), inventory data (e.g., online inventory and in-store inventory), or sales volume (e.g., top seller search). The search application may filter out certain products in ranked list based on filtering criteria (step S18). Filtering criteria are not particularly limited and may include product category, customer ratings, popularity, relevance, availability, manufacturer, brand, vendor, and product features. The filtering criteria may be store specified (e.g., a manager of a store desires to stop promoting a particular product because supplies are low) or customer specified (e.g., a customer indicates that they would like to stop receiving product recommendations for a product they do not purchase, such as Brussels sprouts. Once filtering is complete, the one or more ranked lists of matching products in the inventory may be sent to the terminal (step S19) to be displayed (step S20).

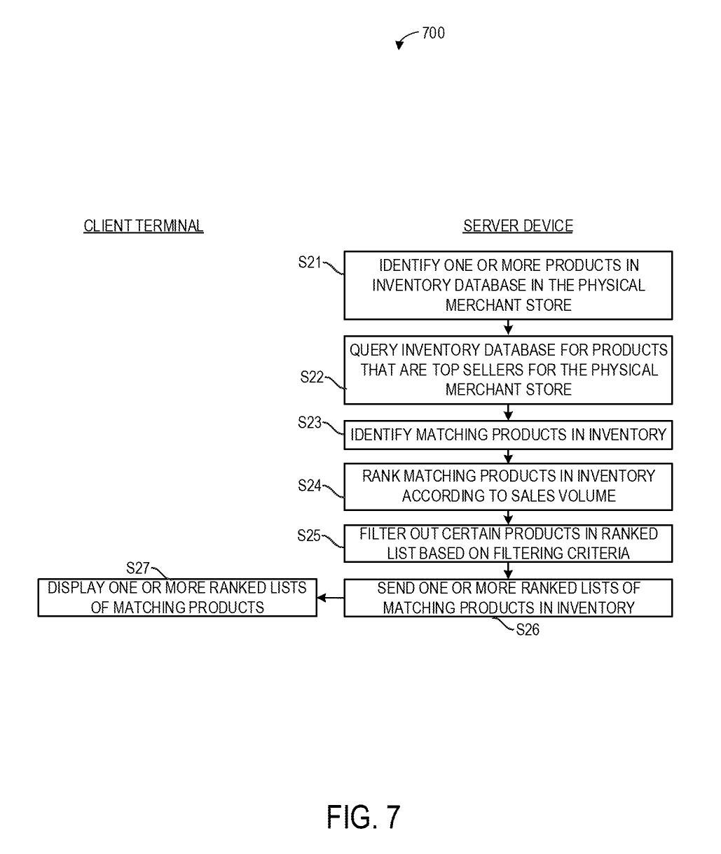

With reference to FIG. 7, the method 700 of FIG. 6 may continue with steps S21 through S27, which may be performed following or in parallel with steps S1-S20. In steps S21 through S27, in contrast to determining a subset of products within a product category according to an algorithm that takes into account a profile of a shopper interacting with a terminal, a location of the terminal inside the physical merchant store, and products that are located in proximity to the terminal, only the products that are top sellers for the physical merchant store are determined and then displayed in a dedicated area of the display of the terminal, as illustrated in the “top in-store sellers” column in FIG. 3A and the “top sellers online” column in FIG. 3C. Functioning in parallel with the method according to FIG. 6, software on the server device, such as the search application, identifies one or more products in the inventory database in the physical merchant store (step S21). The search application sends a search query to the inventory database to find products that are the top sellers for the physical merchant store (step S22). Once the matching products in the inventory are identified (step S23), products in the inventory are rank matched according to ranking criteria (step S24), which is typically dependent on sales volume to show the top selling products. As in the method of FIG. 6, the search application may filter out certain products in the ranked list based on filtering criteria (step S25). Filtering criteria are not particularly limited and may include item margins, product category, customer ratings, popularity, relevance, availability, manufacturer, brand, vendor, and product features. One or more ranked lists of matching products in the inventory may be sent to the terminal (step S26) to be displayed (step S27). It will be appreciated that, unlike the method of FIG. 6, shopper identifiers, position identifiers, the position of the client terminal, and planogram data are not taken into consideration when the rank lists are prepared for display on the terminal. In this manner, the shopper may view both recommendations that are relevant to the place in which the shopper is using the terminal, and which are relevant to the shopper's purchase history and preference as stored in the shopper profile, as well as recommendations that are based upon items that are selling well in the store, independent of whether they are relevant to the surrounding products or to the shopper's profile.

According to the systems and methods described above for applying the long tail strategy to physical merchant stores, the device can present as many varieties of products as possible while taking up minimal retail floor space, which is ideal for smaller retail stores, such as convenience stores, that are looking for ways to efficiently utilize retail space. Furthermore, a shopper no longer has to use a personal mobile device to retrieve a store website to browse merchandise or purchase items online—the claimed configuration adds convenience, context, and relevance to the process of accessing online merchandise in a physical merchant store. It is also part of the solution to the problem of excess inventory, allowing a store to strategically control the flow of inventory, delivering the right items, at the right time, in the right amounts. This enables store owners to stock fewer items, saving on real estate costs, while still servicing customer needs in a timely manner.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. An interactive transaction system comprising:
a terminal located inside a physical merchant store adjacent or in proximity to a merchandise display, the terminal comprising a touch screen device, associated with a product category, configured to:
present a subset of products within the product category, the subset of products within the product category being determined according to an algorithm that takes into account a profile of a shopper interacting with the terminal, a location of the terminal inside the physical merchant store, and products that are located in proximity to the terminal; and
receive a shopper selection associated with at least one of the products in the subset of products within the product category for fulfillment.

2. The interactive transaction system of claim 1, wherein the terminal is configured to:
receive a shopper request to purchase and receive during a current visit at least one of the products selected by the shopper.

3. The interactive transaction system of claim 1, wherein the terminal is configured to:
receive a shopper request to purchase for later delivery at least one of the products selected by the shopper.

4. The interactive transaction system of claim 1, wherein the terminal is configured to:
receive a shopper request to purchase with a predetermined subscription order at least one of the products selected by the shopper.

5. The interactive transaction system of claim 2, wherein the request to purchase and receive purchased products during current visit is accepted when the one or more products selected by the shopper is confirmed to be in a saleable inventory in a stock portion of the physical merchant store.

6. The interactive transaction system of claim 2, wherein the request to purchase and receive purchased products during current visit is rejected when the at least one of the products selected by the shopper is not in a saleable inventory stored in a stock portion of the physical merchant store, and the shopper request is received to purchase for later delivery or to purchase with the predetermined subscription order the at least one of the products selected by the shopper.

7. The interactive transaction system of claim 1, wherein the algorithm is based on a sales history associated with the profile of the shopper.

8. The interactive transaction system of claim 1, wherein the algorithm is based on an overall sales history associated with profiles of multiple shoppers.

9. The interactive transaction system of claim 1, wherein the algorithm is based on a saleable inventory in a stock portion of the physical merchant store or a warehouse.

10. The interactive transaction system of claim 1, wherein the algorithm preferentially chooses sponsored or promoted products within the product category to present to the shopper.

11. The interactive transaction system of claim 1, wherein each product in the physical merchant store is an RFID-tagged item.

12. The interactive transaction system of claim 1, wherein the profile of the shopper is authenticated using a card with a magnetic stripe.

13. The interactive transaction system of claim 1, wherein the profile of the shopper is authenticated by entering a unique alphanumeric sequence.

14. The interactive transaction system of claim 1, wherein the profile of the shopper is authenticated using a card with a microchip.

15. The interactive transaction system of claim 1, wherein the products are presented within a virtual store space according to a planogram.

16. The interactive transaction system of claim 1, wherein audio aids in the shopping environment guide shoppers to products.

17. The interactive transaction system of claim 1, wherein visual aids in the shopping environment guide shoppers to products.

18. An interactive transaction method, for use with a terminal positioned within a shopping environment, the method comprising:
providing a terminal located inside a physical merchant store adjacent or in proximity to a merchandise display, the terminal including a touch screen device, associated with a product category;
presenting, via the terminal, a subset of products within the product category, the subset of products within the product category being determined according to an algorithm that takes into account a profile of a shopper interacting with the terminal, a location of the terminal inside the physical merchant store, and products that are located in proximity to the terminal; and
receiving, via the terminal, a shopper selection associated with at least one of the products in the subset of products within the product category for fulfillment.

19. The method of claim 18, further comprising:
sending a position identifier from the terminal to a server device; and
identifying the product category as being adjacent the position of the terminal within planogram data based on the position identifier.

20. The method of claim 19, further comprising:
sending a shopper identifier from the terminal to the server device.

21. The method of claim 20, further comprising:
at the server device, querying a database for products in online, in store, or on shelf inventory that match the identified product category;
ranking matching products according to ranking criteria; and
sending a ranked list of the matching products to the terminal, the ranked list being the subset of products.

22. The method of claim 21, further comprising:
displaying a list of top selling products in the shopping environment on the terminal, irrespective of the position of the terminal.
